(19) United States
(12) Patent Application Publication
(10) Pub. No.: US 2025/0378123 A1
(43) Pub. Date: Dec. 11, 2025

(54) SYSTEM AND METHOD FOR AUTOMATED UNIVERSAL RESOURCE LOCATOR CREATION

(71) Applicant: Gabriel Lang Smallman, Amherst, MA (US)

(72) Inventor: Gabriel Lang Smallman, Amherst, MA (US)

(21) Appl. No.: 19/222,537

(22) Filed: May 29, 2025

Related U.S. Application Data
(60) Provisional application No. 63/657,187, filed on Jun. 7, 2024.

(51) Int. Cl. G06F 16/955; G06F 16/215

(52) U.S. Cl. CPC G06F 16/9566; G06F 16/215

(57) ABSTRACT

A system and method for automated bulk creation of Universal Resource Locators (URLs) with embedded Urchin Tracking Module (UTM) parameters is disclosed. The method processes input data, including endpoint URLs and UTM parameters, through pre-processing steps such as data cleansing and format standardization. The method appends UTM parameter-value pairs to endpoint URLs, optionally encoding the parameters. The generated tracking URLs are stored in a structured database for seamless integration with analytics tools, enabling reliable tracking and actionable insights into web traffic and user behavior.

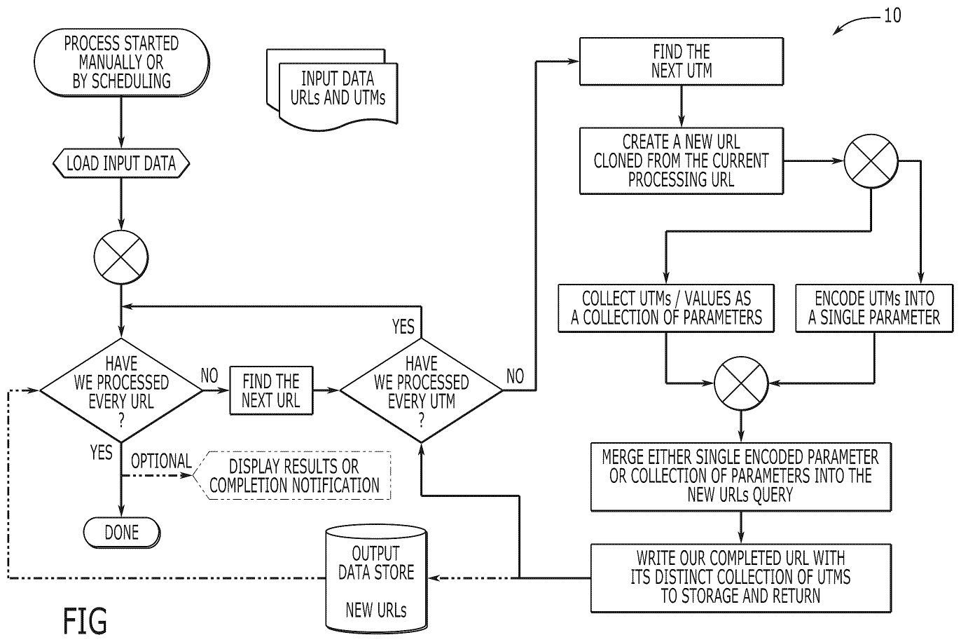

### CROSS-REFERENCE TO RELATED APPLICATIONS

This application claims benefit to Provisional Application No. 63/657,187, filed Jun. 7, 2024, the contents of which are herein incorporated by reference.

### BACKGROUND OF THE INVENTION

### Field of Endeavor

The present disclosure pertains to online marketing technologies, specifically to systems and methods for automated creation of Universal Resource Locators (URLs) with embedded Urchin Tracking Module (UTM) parameters for tracking and analytics purposes.

### Background of Related Art

The field of online marketing encompasses a wide range of technologies designed to monitor, analyze, and optimize digital campaigns. In today's data-driven environment, organizations increasingly depend on systems that assemble tracking elements to monitor web traffic and user interactions. These systems play a significant role in measuring the performance of marketing initiatives and ensuring that strategic decisions are backed by reliable and timely data. As companies continue to explore avenues for increased operational efficiency and more insightful analytics, there is a consistent drive to refine the processes that underpin campaign tracking and data collection.

In many digital marketing applications, one primary focus is to streamline the integration between campaign activities and analytical platforms. Businesses aim to achieve a seamless connection between marketing efforts and the generation of performance metrics. This goal plays a significant role in ensuring that actionable insights are derived quickly and accurately, which in turn supports dynamic decision-making and strategy adjustments in real time. The need for robust tools that can reliably process and categorize marketing data has become more pronounced, especially as the volume of online engagement continues to rise.

Tracking marketing information in the Live-venue Live-event industry typically requires manual generation of URLs with UTM information embedded therein. UTM information include at least five variants of URL parameters which are useful for tracking the effectiveness of online marketing campaigns across a plurality of traffic sources. Typically, UTM parameters identify the specific campaign that referred traffic to the URL, among other information. These UTM parameters can be parsed by analytics tools to determine a number of metrics. Manual generation of URLs with UTM information is an industry standard, however this process is time consuming, labor intensive, and prone to human error.

As can be seen, there is a need for a system and method for automated bulk creation of URLs with UTM information that can reduce the time and error rate associated with manual creation.

### SUMMARY OF THE INVENTION

In one embodiment, a computer implemented method for automated bulk generation of tracking Uniform Resource Locators (URLs) with embedded Urchin Tracking Module (UTM) parameters is disclosed. The method includes receiving input data comprising a plurality of endpoint URLs and one or more UTM parameters; iteratively selecting an endpoint URL from the plurality; cloning the selected endpoint URL to form a tracking URL template; and, for each UTM parameter associated with the selected endpoint URL, determining whether encoding is required. When encoding is required, the UTM parameter is encoded and appended to the tracking URL template, and when encoding is not required, the UTM parameter is appended in plain-text format. The resulting tracking URL with the appended UTM parameters is stored in a data repository, and these steps are repeated until all endpoint URLs have been processed.

### BRIEF DESCRIPTION OF THE DRAWINGS

The figure is a flow chart diagram illustrating one embodiment of a method for automated bulk creation of URLs with UTM parameters.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The field of online marketing relies heavily on tracking and analyzing user interactions to measure the effectiveness of campaigns and inform strategic decision-making. Because online marketing is necessarily rooted in computing environments, a critical technical aspect of this process of creating Universal Resource Locators (URLs) embedded with Urchin Tracking Module (UTM) parameters, which are parameters particular to the online environment of the Internet. These UTM parameters, which include pairs of information such as campaign source, medium, and name, enable analytics tools to parse and generate actionable insights regarding web traffic and user behavior. However, conventional methods for generating URLs with UTM parameters are predominantly manual, requiring significant time and effort while being prone to human error. Improper formatting, inconsistent parameter usage, and lack of standardization in UTM creation can lead to unreliable tracking data, complicating integration with analytics platforms and limiting the ability to derive meaningful insights.

The present disclosure addresses these limitations by introducing a system and method for automated bulk creation of URLs with UTM parameters. This approach significantly improves upon prior methods by eliminating the need for manual URL generation, thereby reducing errors, enhancing operational efficiency, and standardizing the formatting of tracking URLs. The system utilizes a structured process that ingests input data, such as endpoint URLs and UTM codes, and processes this data using specialized algorithms to generate tracking URLs in bulk. By automating the encoding and appending of UTM parameters to endpoint URLs, the described system ensures consistent and accurate tracking information while enabling seamless integration with analytics tools.

Broadly, the solution involves pre-processing input data, loading the data into computer memory, and iteratively generating tracking URLs by appending UTM parameters to endpoint URLs. The system can encode UTM parameters to optimize their format and size, ensuring compatibility with various applications. Once the tracking URLs are created, these URLs are stored in a database for future use. This automated approach not only streamlines the URL creation process but also provides a reliable and auditable history of tracking data, enhancing the overall efficiency and accuracy of marketing campaign analytics.

The figure illustrates method 10 for bulk creation of UTM parameters and linking the parameters to URLs is illustrated. Briefly, and described in more detail below, method 10 receives one or more endpoint URLs and processes the one or more endpoint URLs to form a tracking URL having one or more UTM parameters.

In embodiments, prior to processing one or more pre-processing steps can, optionally, occur. In embodiments, pre-processing includes ingestion of one or more endpoint URLs, one or more UTMs keys, one or more UTM values. Additionally, pre-processing includes data cleansing operations such as: format standardization of data, data splitting such as splitting UTM keys from UTM values, noise removal, etc. In embodiments, Endpoint URLs can be uploaded as a file, transmitted across the internet, or entered with manual data entry, and stored in a data store, or database, accessible by a computing system. UTM codes can be uploaded as a file, transmitted across the internet, or entered with manual data entry, and kept in a data store, or database, accessible by a computing system.

The figure illustrates a method 10 for automated bulk creation of tracking URLs by appending one or more UTM parameter/value pairs to one or more endpoint URLs, with optional encoding of the UTM parameters. The method begins with the initiation of the process, which can be triggered manually or through a scheduling mechanism. This flexibility allows the computing system performing method 10 to adapt to various operational requirements, such as real-time campaign tracking or batch processing during off-peak hours.

The first step involves loading input data, which includes endpoint URLs and UTM parameters. The input data can be ingested in various formats, such as CSV files, JSON objects, or XML documents, and stored in a data repository accessible by the system performing method 10. This step ensures that the input data is validated and structured for efficient processing. The loaded data typically includes endpoint URLs and UTM parameters, such as key/value pairs, which are necessary for generating tracking URLs.

In an exemplary embodiment, the one or more endpoint URLs can be static or dynamic and reference one or more endpoints for live in-venue events. Additionally, the one or more UTM parameters include one or more keys and or one or more values associated with the one or more keys. In embodiments, the one or more keys are the name of a UTM parameter, which identifies the type of information being tracked. Common UTM keys include: utm_source which identifies the source of the traffic, such as a search engine, newsletter, or social media platform; utm_medium which specifies the marketing medium, such as email, pay-per-click (PPC), or banner ads; utm_campaign which indicates the specific campaign name or identifier, such as “spring_sale” or “product_launch.”; utm_term which is used to track specific search terms, often in paid search campaigns; and/or utm_content which differentiates between similar content or links within the same campaign, such as “logolink” or “textlink.” In embodiments, the one or more values are a specific data associated with the key, which provides detailed information about the campaign. For example, for key utm_source, the value can be “google” to indicate that the traffic originated from Google; for key utm_medium, the value might be “email” to specify that the traffic came from an email campaign; and/or for key utm_campaign, the value might be “holiday_promo” to identify the campaign driving the traffic.

Once the input data is loaded, method 10 evaluates whether all endpoint URLs have been processed. If all URLs have been processed, method 10 terminates, optionally displaying results or a completion notification. If processing remains incomplete, the method proceeds to find the next endpoint URL for processing. This iterative approach ensures that each endpoint URL is systematically processed.

Method 10 then evaluates whether each UTM for the selected endpoint URL has been process, and if so, method 10 returns to the determination if each endpoint URL has been processed. If each UTM for the selected endpoint URL has not been processed, a next UTM is selected by system performing method 10.

In embodiments, a URL is cloned from the current selected endpoint URL. This step duplicates the scheme, host, path, and existing parameters of the selected endpoint URL to form a template for the tracking URL. This template serves as the foundation for appending UTM parameters of the next UTM, ensuring that the base structure of the URL remains intact.

Once the tracking URL is selected a determination is made as to whether the next UTM is to be encoded. If the next UTM is not to be encoded each key/value pair of the next UTM is collected as a collection of parameters and merge or appended to a query string of the tracking URL. In embodiments, each key/value pair of the next UTM is appended to the tracking URL in plain-text format. If it is determined the UTM parameters should be encoded, then all the keys and values of the UTM parameters are encoded and appended or merged to the query string of the tracking URL with an appropriately named key. In embodiments, encoding can take any known form that reduces the amount, size, or number of characters in the UTM parameters, such as URL encoding, compression, or hashing, depending on the system's requirements.

Once the tracking URL is completed, the tracking URL is stored in a data repository along with associated UTM parameters. This storage step provides a reliable and auditable history of tracking data, enabling efficient retrieval and analysis. The stored URLs are organized in a structured format, supporting operations such as querying, filtering, and exporting for integration with analytics tools or additional applications.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a non-transitory machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Generally, a computer will also include a communications device. The communication device can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

It should be understood, of course, that the foregoing relates to exemplary embodiments of the invention and that modifications may be made without departing from the spirit and scope of the invention as set forth in the following claims.

What is claimed is:

1. A computer implemented method for automated bulk generation of tracking Uniform Resource Locators (URLs) with embedded Urchin Tracking Module (UTM) parameters, the method comprising:
receiving, at a processor, input data comprising: a plurality of endpoint URLs and one or more UTM parameters;
iteratively selecting, by the processor, an endpoint URL from the plurality of endpoint URLs;
cloning, by the processor, the selected endpoint URL to form a tracking URL template;
for each of the one or more UTM parameters associated with the selected endpoint URL, determining, by the processor, whether the one or more UTM parameters requires encoding and appending the one or more UTM parameters to the tracking URL template, the appending step comprising:
encoding the one or more UTM parameters and appending the encoded one or more UTM parameter to the tracking URL template when encoding is required, or
appending the one or more UTM parameters in plain-text format when encoding is not required;
storing, by the processor, the tracking URL with the appended one or more UTM parameters in a data repository; and
repeating the steps of iteratively selecting, cloning, appending, and storing until each of the plurality of endpoint URLs has been processed.

2. The computer implemented method of claim 1, further comprising:
pre-processing, by the processor, the input data to perform data cleansing and format standardization of the plurality endpoint URLs and one or more UTM parameters.

3. The computer implemented method of claim 1, wherein the one or more UTM parameters each have a key and a value associated with the key.
